(19) United States
(12) Patent Application Publication
(10) Pub. No.: US 2005/0202795 A1
(43) Pub. Date: Sep. 15, 2005

(54) Method for synchronizing or decoding a baseband signal

(76) Inventors: YaFei Tian, Beijing (CN); Chenyang Yang, Beijing (CN); Feng Wu, Beijing (CN); Liang Zhang, Beijing (CN); Liang Li, Mission Viejo, CA (US); Noi Banavong, Yorba Linda, CA (US)

Correspondence Address: William J. Kolegraff, 3119 Turnberry Way, Jamul, CA, 91935, US

(21) Appl. No.: 10/422,321

(22) Filed: Apr. 24, 2003

Related U.S. Application Data
(60) Provisional application No. 60/391,888, filed on Jun. 27, 2002.

(51) Int. Cl. H04B 1/16; H04B 1/06; H04B 7/00

(52) U.S. Cl. 455/255; 455/208

(57) ABSTRACT

A baseband process operating on a receiver in a communication system, such as an 802.15.4 communication system, is provided. The baseband process has a set of predefined reference signals, with each reference signal associated with a possible characteristic in the baseband signal. The baseband process receives a degraded baseband signal, and preprocesses the baseband signal to reduce or remove the effects of the degradation. The preprocessed baseband signal is correlated with reference signals from the set of predefined reference signals, and the reference signal with the best correlation is identified. By identifying the best correlating reference signal, the baseband process is able to identify a characteristic of the baseband signal. In one example of the baseband process, the baseband signal is preprocessed by auto-correlating the degraded baseband signal with a delayed version of the degraded baseband signal. The preprocessed baseband signal is then correlated against a set of sync reference signals to find a sync offset for the baseband signal. When synchronized with the baseband signal, the baseband process may be correlated against a set of symbol reference signals to decode sequential symbols in the baseband signal.

This application claims benefit of priority to U.S. patent application No. 60/391,888 filed Jun. 27, 2002 and entitled “Demodulation Algorithm for the 802.15.4 Receiver”, and to U.S. provisional application______filed Sep. 13, 2002, entitled “A Kind of Low Complexity Receiver Structure for the Wireless Transceiver Based on IEEE 802.15.4 Standard at 2.4 GHz”, both of which are incorporated herein by reference.

### BACKGROUND

The field of the present invention is receivers for communications systems. In a particular example, the invention relates to a baseband receiver process operating on a receiver for receiving a communication signal compliant with the 802.15.4 standard.

Receivers form an important part of any communications system. Receivers cooperate with a transmitting device to receive an information signal and decode the information from that signal. In practice, the receiver portion is often coupled with the transmitter portion to create a transmitter. Often, this transmitter is portable so that a wireless communication may be received irrespective of location. In its portable form, it is particularly desirable to have the receiver operate with low power and be implemented in a cost efficient manner. In this way, the portable device has an affordable initial cost, and may operated for extended periods of time using a portable energy source such as a battery. However, although low cost and low power usage are desirable characteristics, the primary demand on a portable receiver is to accurately and efficiently decode a received signal, and to remain compliant with the appropriate communication standard.

Most modern communication systems comply or are based upon one or many communications standards. These communications standards are promulgated by industry associations and groups to facilitate interoperability between devices. For example, the IEEE is an organization responsible for promulgating several communication standards. Each communication standard has particular strengths and goals, and also certain associated implementation costs. For example, communication standards operating at very high data rates tend to operate over the greatest distances, allow for the greatest number of users, and are the most expensive to implement. Other communication standards set a relatively low data rate, a relatively low number of users, and may be relatively inexpensive to implement. One standard, the 802.15.4 standard is intended to be a relatively low cost and low power wireless communication standard. With the relatively low data rate, 802.15.4 compliant devices are expected to be targeted to such markets as industrial sensors, commercial metering, consumer electronics, toys and games, and home automation. Each of these markets has a great cost sensitivity, and will expect that any portable device efficiently use its battery or other portable energy source.

The 802.15.4 specification operates at either 2.4 GHz or about 900 MHz, and uses a wireless transmission technology to dynamically configure and initialize a personal area network. The standard particularly sets out implementations and structures for the transmitter portion of the communication systems, but is far less detailed in describing receiver implementations.

Implementing a receiver for the 802.15.4 has been made particularly difficult due to the overall architecture of the 802.15.4 network. According to the standard, the transmitter does not provide a separate synchronization process to allow a receiver to synchronize to the transmission. Instead, 802.15.4 relies upon self-synchronization by the receiver. Self-synchronization can be a time consuming and processor intensive process, thereby using scarce power resources available at the portable receiver. Further, the standard allows the frequency of a transmission to vary as much as 60 parts per million (ppm) when operating at the 2.4 GHz band. Further, the magnitude of the frequency offset between devices may vary depending upon time, temperature, and will fluctuate substantially depending on which specific device is transmitting. Thus the standard permits the transmitter to introduce a substantial 60 ppm (about 150 kHz) frequency offset at each receiver, which is substantial, variable and unpredictable.

The 802.15.4 standard is also a channel architecture, with the usual adjacent channel interference, fading, and noise associated with such an architecture. The signal coming from an 802.15.4 transmitter, therefore suffers from degradation from a substantial frequency offset, adjacent channel interference, fading, noise, and possibly other degrading factors. In this way, the receiver needs to be constructed to properly self-synchronize and decode the incoming 802.15.4 signal, even when the signal is highly degraded.

As with many communication systems, the 802.15.4 communication system is a framed based system. As such, the transmitter assembles a data frame, encodes the data frame, modulates the data frame onto a carrier frequency, and transmits the modulated information signal to the receiver. The receiver is expected to detect the modulated signal, remove the carrier to generate a baseband signal, and synchronize with and decode the baseband signal. In the 802.15.4 standard, the frame has an 8-symbol preamble, which indicates the presence of a data frame. Accordingly, the 802.15.4 compliant receiver must synchronized to the baseband signal within only 8 symbols. The process of synchronizing to a degraded asynchronous baseband signal with only 8 symbols is typically accomplished by either providing for substantial parallel processing capability in the form of a complex gate configuration, or providing a relatively high speed processor for quickly performing algorithmic calculations. Either solution tends to use substantial power and be implemented with high end and relatively high cost parts. In this way, even though the 802.15.4 standard is intended to be a low power and low cost arrangement, the architectural constraints of the standard may hinder building such a low cost and low power receiver. Therefore it would be desirable to have a receiver process operating on a receiver that could reliably recover information from a highly degraded baseband signal, but yet realizable in a relatively low cost and relatively low power construction.

### SUMMARY

Briefly, the present invention provides a baseband process operating on a receiver in a communication system, such as an 802.15.4 communication system. The baseband process has a set of predefined reference signals, with each reference signal associated with a possible characteristic in the baseband signal. The baseband process receives a degraded baseband signal, and preprocesses the baseband signal to reduce or remove the effects of the degradation. The preprocessed baseband signal is correlated with reference signals from the set of predefined reference signals, and the reference signal with the best correlation is identified. By identifying the best correlating reference signal, the baseband process is able to identify a characteristic of the baseband signal. In one example of the baseband process, the baseband signal is preprocessed by auto-correlating the degraded baseband signal with a delayed version of the degraded baseband signal. The preprocessed baseband signal is then correlated against a set of sync reference signals to find a sync offset for the baseband signal. When synchronized with the baseband signal, the baseband process may be correlated against a set of symbol reference signals to decode sequential symbols in the baseband signal.

Advantageously, the disclosed baseband process provides a highly efficient method for synchronizing to a baseband signal and decoding symbol data from the baseband signal. In one example, the baseband process is able to synchronize to a degraded baseband signal, irrespective of the frequency offset in the transmitted RF signal. The synchronization is completed on the preamble portion of a data frame, and may be implemented in a relatively low cost and low power configuration. These and other advantages will become apparent by review of the figures and detail descriptions that follow.

### BRIEF DESCRIPTION OF THE DRAWINGS

FIG. 1 is a block diagram of a baseband process in accordance with the present invention;

FIG. 2 is a block diagram of a device architecture for a baseband receiver;

FIG. 3 is a block diagram of a baseband process in accordance with the present invention;

FIG. 4 is a flowchart of a baseband sync and decode process in accordance with the present invention;

FIG. 5 is a block diagram of a baseband sync and decode process in accordance with the present invention;

FIG. 6 is a flowchart of a baseband sync and decode process in accordance with the present invention;

FIG. 7 is a block diagram of a receiver in accordance with the present invention;

FIG. 8 is an illustration of a baseband signal waveform in accordance with the present invention;

FIG. 9a is a block diagram of a baseband process in accordance with the present invention;

FIG. 9b is a block diagram of another baseband process in accordance with the present invention;

FIG. 10 is a block diagram of a process to predetermine signals for a reference table in accordance with the present invention;

FIG. 11 is a block diagram of a baseband process in accordance with the present invention;

FIG. 12 is a symbol table useful in one example of a receiver in accordance with the present invention;

FIG. 13 is a block diagram of a process to predetermine signals for a reference table in accordance with the present invention;

FIG. 14 is a block diagram of a baseband process in accordance with the present invention;

FIG. 15 is a block diagram of a baseband receiver in accordance with the present invention;

FIG. 16 illustrates mathematical support for a baseband process locating a sync offset in accordance with the present invention; and

FIG. 17 illustrates mathematical support for a baseband process decoding symbol data in accordance with the present invention.

### DETAILED DESCRIPTION

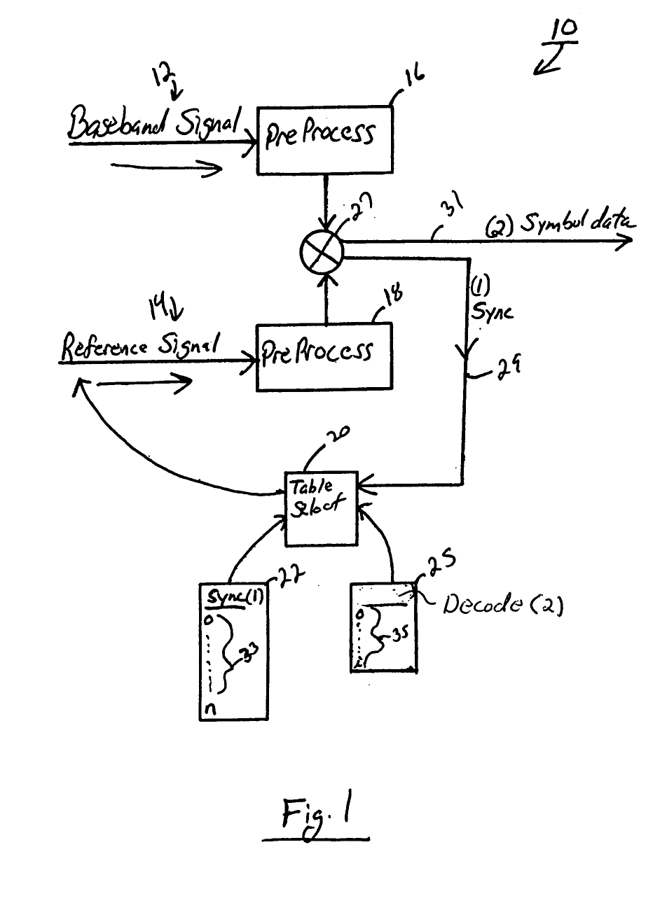

Referring now to FIG. 1, a baseband process 10 is illustrated. The baseband process 10 operates on a baseband portion of a communication receiver system. For example, the receiver may be part of a transceiver configured to communicate on a wireless network such as an 802.15.4 compliant network. Although the process 10 will be described operating in the 802.15.4 standard, it will be appreciated that the baseband process may be configured to function with other communication systems and standards. In general, baseband process 10 is useful for identifying particular characteristics in the baseband signal. For example, such characteristics may be the presence of a synchronization signal or the presence of a data symbol. It will be appreciated that the baseband process 10 maybe useful for identifying other characteristics of a baseband signal.

Baseband process 10 provides a highly efficient method for first synchronizing to a baseband signal and then decoding symbol data from the baseband signal. The efficiency of the baseband process 10 enables a particularly efficient and low power receiver configuration. Accordingly, baseband process 10 is useful is the receiver portion of an 802.15.4 transceiver, where low power usage and low implementation costs are important considerations.

Baseband process 10 receives a baseband signal 12 from another portion of the receiver. The baseband signal 12 has been demodulated to remove the carrier frequency, however the effects due to a frequency offset, noise, interference, fading, and time shift are still present in the baseband signal 12. Since the carrier signal has been removed from the baseband signal 12, baseband signal 12 generally represents a waveform carrying pulse information. The shape of the pulses generally relate to a binary encoding, however, the pulse shape may be substantially deformed due to the frequency offset, noise, and other degrading influences. In block 16 the baseband signal is received and preprocessed. The preprocess block 16 efficiently removes the effects of frequency offset. The preprocess block 16 then forwards the improved baseband waveform into a correlator 27. A reference signal 14 is received into preprocess block 18. Preprocess block 18 maybe similar to preprocess block 16. However, it will be appreciated that preprocess block 18 may be simplified as reference signal 14 will not be subjected to unknown frequency offsets, noise and other such degrading influences. Instead, reference signal 14 is a waveform signal retrieved from a stored table. The stored tables hold predefined reference waveforms for use by the baseband process 10. In one example of the baseband process 10, a sync reference table 22 and a decode reference table 25 may be selected to provide the reference signal 14 that is input to the preprocess block 18.

In operation the baseband process 10 has a table select function 20 that selects if the reference signal 14 is provided from the sync reference table 22 or the decode reference table 25. In one sequence of events, the table select 20 first provides the reference signal 14 from the sync reference table 22. In this way, one of the sync reference waveforms 33 is input to the preprocess block 18, where the reference signal is processed and then passed to correlator 27. A baseband signal 12 is also received at the preprocess block 16 with the improved baseband waveform passed into the correlator 27. The correlator then provides an indication of the relative correlation between the preprocessed baseband signal and the preprocessed reference signal. For example, if the preprocessed baseband signal and preprocessed the reference signal have a high degree of correlation, then the correlator 27 will output an indicator of a high power level. However, if the preprocessed baseband signal and the preprocessed reference signal have a low lever of correlation, then the correlator 27 will output an indicator of a lower power level. Each of the reference signals 33 is passed through the baseband process 10 so that each of the preprocessed reference waveforms is correlated against the preprocessed baseband signal. The preprocessed reference signal having the highest level of correlation with the preprocessed baseband signal is an indicator that the desired characteristic has been located in the baseband signal. For example, when the preprocessed reference signals are received from the sync reference table 22, the preprocessed reference waveform 33 having the best correlation with the preprocessed baseband signal provides an indicator that the input baseband signal is synchronized with that preprocessed reference waveform. More particularly, the presence of the highest correlation may provide a synchronization offset value so that the receiver can be synchronized to the baseband signal. It will be appreciated that additional processing may be used to determine if the sync offset or other characteristic actually exists, or if the highest correlator result is a false indicator. For example, a threshold may be set so that the highest correlator result must be higher than the threshold to be considered a valid indicator.

Once the characteristic of the sync or sync offset has been found, the sync 29 may be used to synchronize the receiver, and also may instruct the table select 20 to now provide reference signals from the decode reference table 25. Since the receiver portion is now synchronized with the baseband signal, the baseband process 10 is now able to decode the baseband signal waveform into symbol or other data. In a process similar to the process used to find the synchronization offset, each of the waveforms in a set of decode reference waveforms 35 are input as the reference signal 14 to the preprocess 18. In this way, each of the decode reference waveforms 35 will be correlated against the synchronized baseband signal in correlator 27. The highest correlating decode reference waveform will indicate that an important characteristic in the baseband signal has been located. Here, each of the decode reference signals has an associated data symbol. Accordingly, when the highest correlating decode reference signal has been found, this indicates the associated symbol data has been identified in the baseband signal. The identified symbol data can then be output as symbol data 31. It will be appreciated that additional processing may be done on the symbol data to further decode the symbol, or to further verify the integrity of the symbol. The baseband process 10 may then repeated for each expected symbol cycle in the baseband signal.

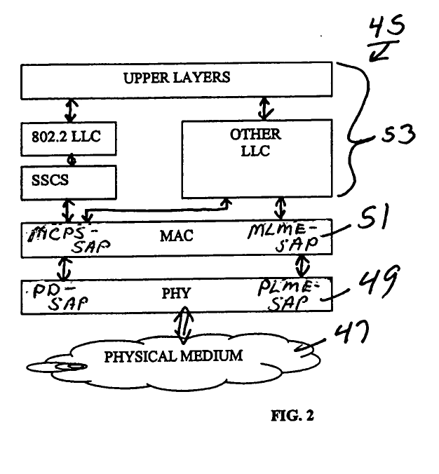

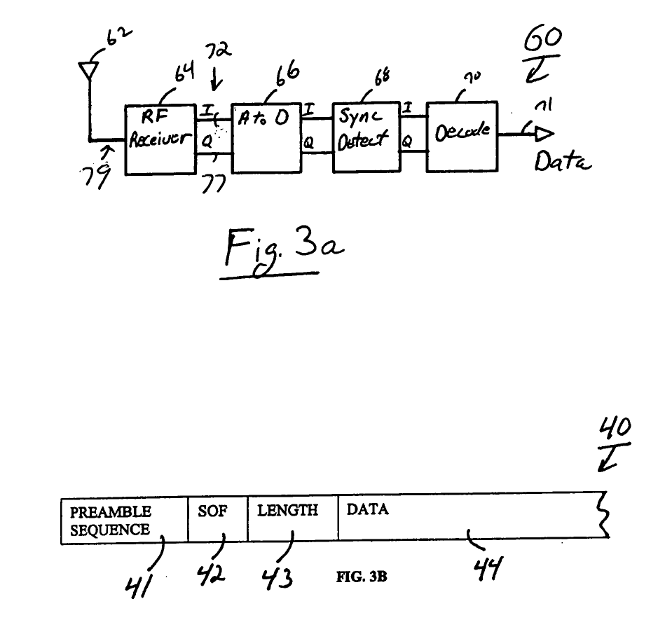

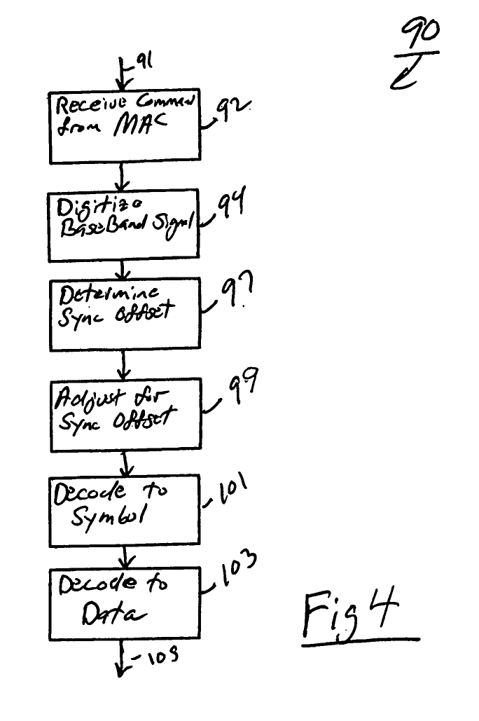

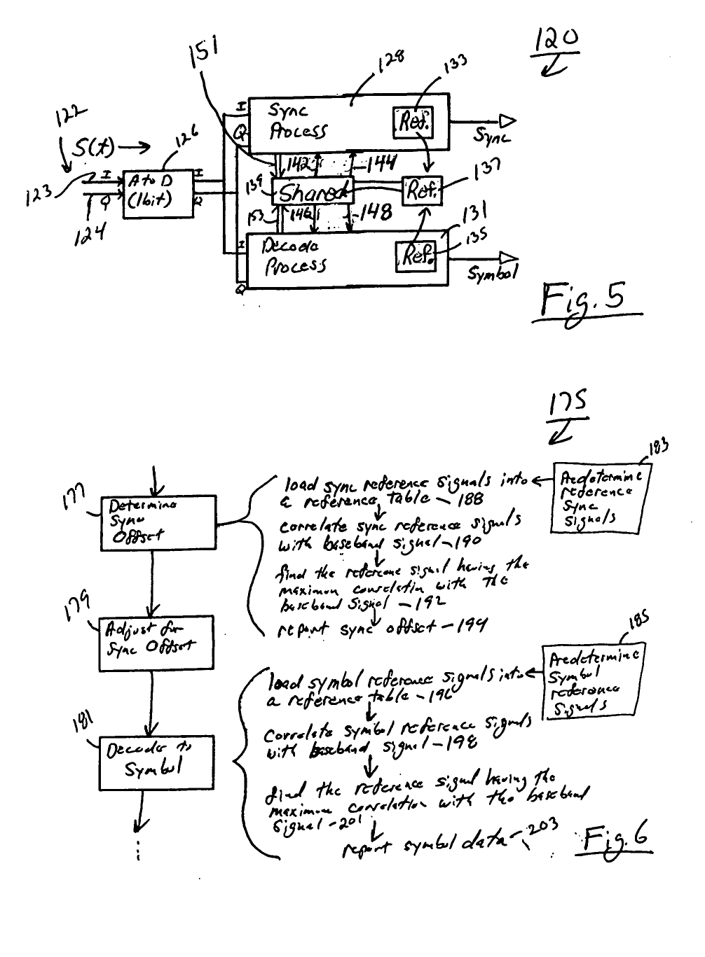

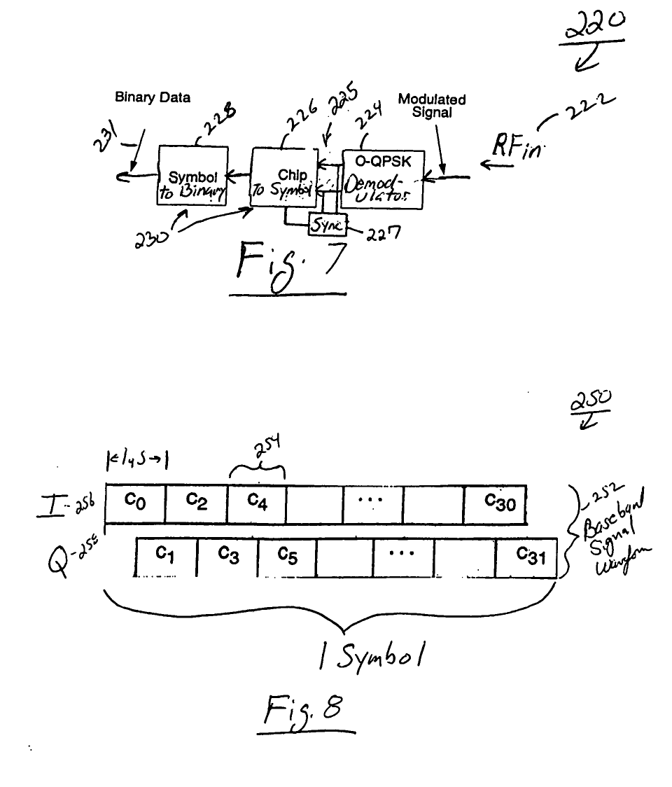

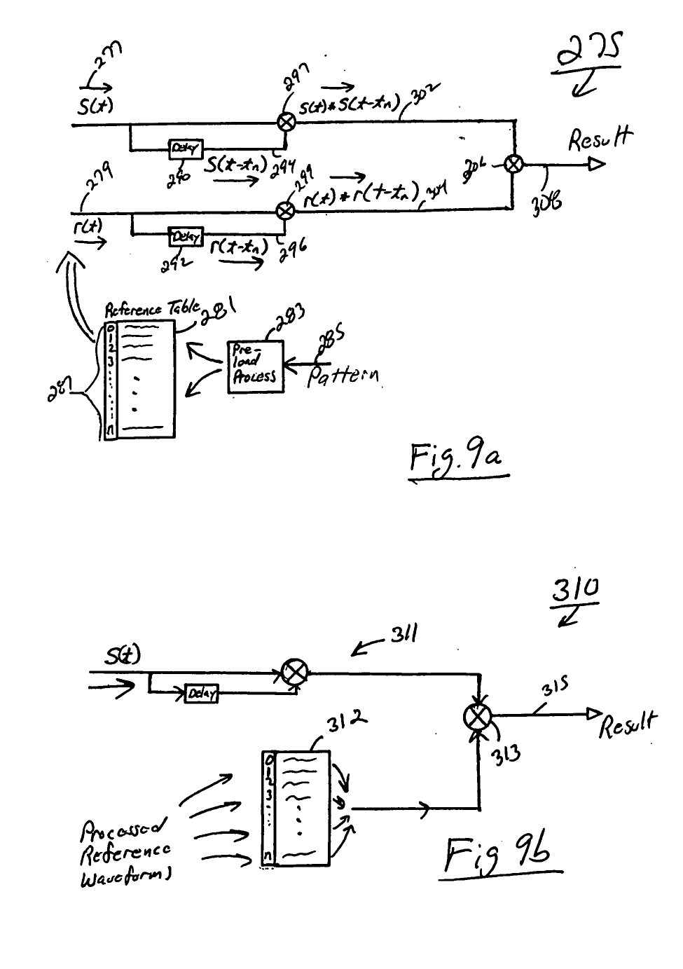

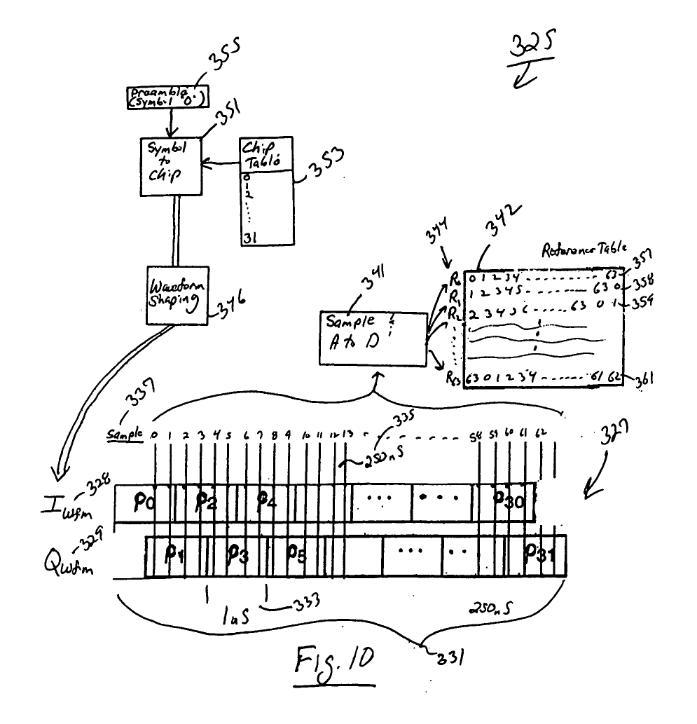

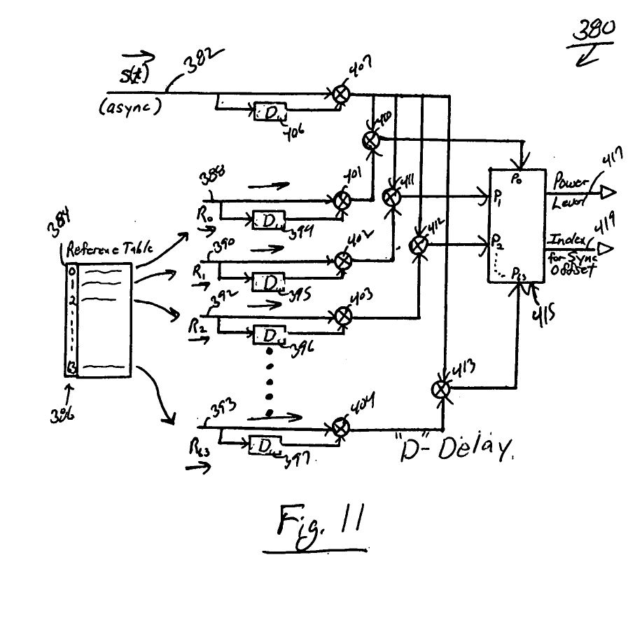

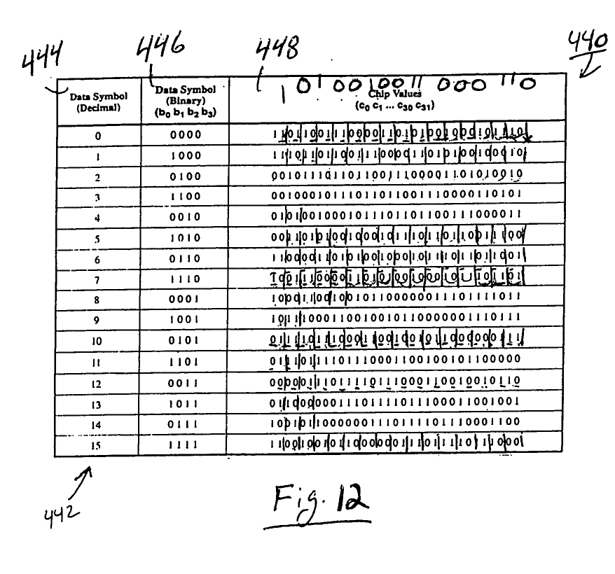

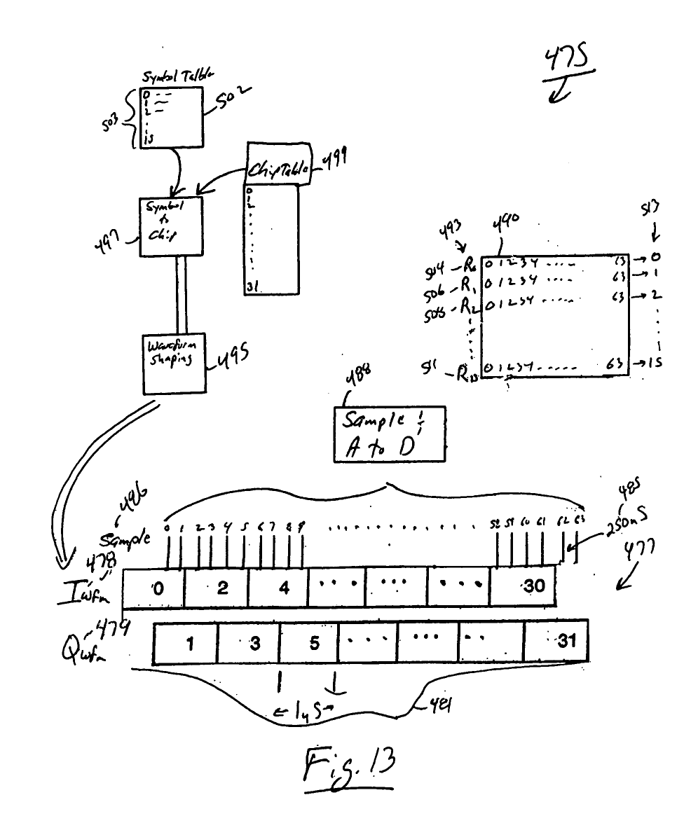

FIG. 2 shows a general device architecture 45 for a wireless communication receiver. More particularly, the device architecture 45 is the general device architecture for an 802.15.4 compliant receiver. The device operates in a physical medium 47, such as the open air. Other receivers may operate with different physical mediums, such as twisted pair or cable transmission mediums. The physical medium 47 couples to the physical layer 49 of the transceiver device. The physical layer 49 of the device is responsible, among other things, for data transmission and reception. Accordingly, the baseband process described earlier operates primarily on the physical layer. The physical layer 49 may receive instructions, data, and commands from the media access layer (MAC) 51, which receives commands from upper layers 53 of the device such as the application layers.

Referring now to FIG. 3A, a general receiver architecture 60 is described. The receiver 60 has an antenna 62 receiving an RF (radio frequency) signal. The RF signal 79 is received into an RF receiver 64. The RF receiver 64 may be, for example an offset quadrature phase shift key demodulator (O-QPSK). The operation of an O-QPSK demodulator is well known, and therefore will not be described herein. The QPSK demodulator outputs a baseband signal 72. The baseband signal 72 comprises an in-phase (I) portion 75, and a quadrature phase (Q) portion 77. The baseband signal 72 is sent to an analog to digital (A to D) converter 66. The A to D converter 66 quantitizes the baseband signal and passes the result to a sync detector block 68. Since initially the signal passed from the A to D converter is asynchronous, the receiver does not know the starting point for detection and therefore the receiver is responsible for first determining a synchronization point. Further, the network does not provide a synchronization assist, so the receiver is solely responsible for synchronizing to the incoming RF signal. Once the sync detector block 68 has determined the synchronization, then the A to D may be synchronized to the incoming baseband signal. In this way the decode block 70 may then efficiently decode individual data symbols into data information 71.

FIG. 3B shows the general format used to transmit data in a baseband signal for an 802.15.4 compliance system. It will be appreciated that modifications may be made to the data format consistent with the 802.15.4 standard, and that other formats may be used for other communication systems and standards. The data frame 40 has a preamble section 41 which is followed by a short start-up frame portion 42. Next, a frame length indicator 43 is given, with the date 44 following immediately thereafter. Importantly, the preamble sequence 41 is only 8 symbols long. It is therefore important and highly desirable that the baseband process provide for synchronization within this 8-symbol preamble period so that the receiver is prepared to receive the start frame indicator 42, frame length 43, and the data 44.

Referring now to FIG. 4 another receiver process 90 is described. The receiver process 90 receives communications 91 from upper layers, such as the application layer, which are then transmitted to the MAC layer 92. The MAC layer 92 communicates data and commands to the baseband process, which is primarily operating in the physical layer of the device. For example, the MAC layer may instruct the baseband process to begin the process of searching for a data frame. When the baseband process begins looking for the data frame, the process will digitize the baseband signal 94 and determine a sync offset 97. Once a sync offset 97 has been identified, the receiver can be adjusted for the sync offset as shown in block 99. Now the receiver and receiver process may be synchronized with the incoming baseband signal. At this point the baseband process may be used to decode the baseband signal into symbol data and as shown in block 101, and symbol data can be further decoded into binary data in block 103. The binary data is then communicated as data information 109.

Referring now to FIG. 5 a receiver process 120 is illustrated. Receiver process 120 receives a baseband signal 122 which includes an I portion 123 and a Q portion 124. The baseband signal 122 has been received from an RF demodulator, such as an O-QPSK demodulator. The baseband signal 122 is received into an A to D converter 126. Due to the particular preprocessing method selected for the receiver process 120, it is been found that a 1-bit A to D provides sufficient quantization for the baseband signal 122. The use of a 1-bit A to D converter enables simplified and low cost structures to be used, and facilitates efficient processing to meet the time requirements associated with finding the sync offset. The output from the A to D converter 126 is directed into either the sync process 128 or a decode process 131. In use, the sync process 128 is preformed first until a sync offset is found. Once the sync offset is found, then the decode process can be performed synchronously for more efficient decoding of data symbols.

Advantageously, the sync process 128 and the decode process 131 can share substantial algorithmic and structural processes. For illustration purposes, the shared processes 139 are shown in FIG. 5 between the sync process 128 and the decode process 131. It will be understood that in practice the sync and decode processes can be separated for application specific purposes. Alternatively, the processes may be used individually. For example, the decode process may be used separately if synchronization is provided from another source, such as a network provided signal.

When the receiver process 120 initializes, the receiver has not been synchronized with the network or the baseband signal 122. Accordingly, it is desirable to find a synchronization signal or indicator. More specifically, the sync process 128 is used to find a sync offset value which then is used to synchronized the receiver so the decode process 131 may be efficiently accomplished. The sync process 128 has a set of predefined reference waveforms 133. Since the sync process must be concluded within the preamble section of the data frame, and the preamble symbols are predefined in the communication standard, the reference waveforms 133 represent the expected preamble waveform at different sampling start positions. The sync reference table 133 is loaded into the reference table 137 for the shared process 139. The sync process 128 then passes the digitized baseband signal 151 to the shared process 139, where the shared process 139 then correlates the quantitized baseband waveform with each of the possible sync reference signals in the table. When the best correlating reference waveform has been found, then the shared process 139 passes the highest power level 142 and a sync offset 144 associated with that power level back to the sync process 128. The power level 142 is useful for determining the validity of the sync signal 144. For example, a high power indicator may mean that there is a high likelihood that the sync offset 144 is valid, while a low power reading may indicate an invalid reading, and the receiver may decide to repeat the sync process until a better correlation is found. Once a sync offset 144 is known by the sync process 128, the sync offset 144 may be used to adjust the receiver process so that the start point for each data symbol is known.

Once the sync offset has been located, the reference table 137 is then loaded with a symbol reference waveforms 135. Each symbol reference waveform represents an expected waveform for an individual symbol. For example, if the communication standard defines 16 possible symbols, then each of the 16 symbol reference waveforms in a table will be associated with a particular symbol. The decode process 131 then passes the digitized baseband signal 153 to the shared process 139 where each of the symbol reference waveforms 135 are correlated with the baseband signal. Once the best correlating pair is found, the correlation power level 146 and the symbol data 148 is passed back to the decode process 131. The power level 146 is useful for validating the result received from the shard process 139. For example, if the power level is relatively high, that may indicate the symbol data is valid data, while a relatively low power level may indicate a false symbol data. In the case of a possible false symbol data, the receiver may report to the MAC layer that an error has occurred and request a retransmission of the data. Once the symbol data has been confirmed to be valid, the symbol data may be easily converted into binary data for use by the receiving device.

Referring now to FIG. 6 a receiver process 175 is described. The receiver process 175 is similar to a portion of the receiver process 90 shown in FIG. 4. In receiver process 175, step 177 determines a sync offset for a baseband signal. More particularly step 177 comprises first loading sync reference waveforms into a reference table 188. The sync reference signals are correlated with the baseband signal 190, and the reference signal having the maximum correlation with the baseband signal is identified 192. The sync offset is reported 194, as well as possibly reporting an associated power level to validate the reported sync offset. As generally described above, the reference signals that are loaded into the reference table have been predetermined to correspond to expected waveforms in the preamble 183.

Once the sync offset has been determined, the receiver process can be adjusted for the sync offset as shown in block 179. With the receiver and it's A to D converter synchronized with the incoming baseband signal, the receiver process is ready to decode each symbol sequentially. Since every allowable symbol is defined in the communication standard, the set of predetermined symbol reference waveforms may be constructed for the expected data symbols 185. These expected reference signals are then loaded into a reference table 196, and each of the reference signals is correlated with a baseband signal 198. The reference signal having the maximum correlation with baseband signal is identified 201, and the symbol associated with that reference signal is reported back as symbol data 203. Also, a power level may be reported associated with the symbol data for validation purposes.

Referring now to FIG. 7 a receiver 220 is shown. The receiver 220 has an RF-in signal 222. The RF-in signal is received into an O-QPSK demodulator 224. The QPSK demodulator 224 removes the carrier signal and generates I and Q data. The baseband waveform signal 225, however, is initially provided to the rest of the receiver as an asynchronous waveform, and is likely degraded due to frequency offsets, interference, noise, fading, timing delays, and other degrading influences. In order to decode the baseband signal 225, a sync process 227 is first performed on the baseband signal 225 to locate the start of each symbol. The sync data is passed to the decode section 230. The decode section 230 first converts the baseband waveform 225 from a chip representation into a symbol representation in block 226. The chip decoding process is discussed more fully in the discussion of FIG. 8, which follows below. Once the symbols have been identified in block 226, the symbols may be decoded into binary data 231 in the symbol to binary block 228.

Referring now to FIG. 8, a baseband signal representation 250 is shown. The baseband signal 252 is a baseband signal waveform is a complex waveform that includes an I portion 256 and a Q portion 258. The waveform 252 represents one symbol 251 in a data frame. In the 802.15.4 standard, 16 possible symbols are defined. Each of the symbols is identified by a number “0” to “15” inclusive, and is defined to have a one-to-one correspondence with a binary data pattern (see FIG. 12). For example, the binary pattern “1001” is the data symbol “4”. In another example, the binary data “1001” is represented by symbol “9”. In the transmission process, binary data is first coded into associated symbols, and the each of the symbols is coded into 32 sequential chips. For example, FIG. 12 shows that the symbol “4” will be encoded using the chip pattern of “01010010001011101101100111000011”. Accordingly, each symbol, such as symbol 251, is represented by 32 coded chip portions. As described in the 802.15.4 standard, 16 of the chip portions are used to represent the I data while 16 of the chip portions are used to represent the Q portion 258. Since the chips are clocked at a 2 MHz rate, each of the chips 254 on the I or the Q portions are then one microsecond in duration. In this way each symbol transmits in 16 microseconds, which corresponds to a clock rate of 62.5 kHz. Since each symbol represents 4 binary data points, the binary data information is being transmitted at 250 kHz.

Referring now to FIG. 9a a receiver process 275 is shown. Receiver process 275 receives a baseband signal 277 from another portion of the receiver, such as an O-QPSK demodulator. The baseband signal 277 has had its carrier removed, but still may be highly degraded due to the effects of frequency offset, noise, fading, timing delays, and other degrading influences. In order to remove or minimize the effects of these degrading influences, the baseband signal 277 is correlated with a delayed version of itself, which is a form of auto-correlation. More particularly, the baseband signal 277 is received into correlator 297 and the baseband signal is also delayed by delay 290. The delay 290 generates a delayed signal 294 that is also received into the correlator 297. The baseband signal is correlated with the delayed baseband signal to produce a processed signal 302. The processed signal 302 is then received into another correlator 306.

Since the communication standard defines the allowed symbols and the encoding processes, an expected pattern 285 may be determined. For example, the preamble pattern in the 802.15.4 standard is a series of 8 “0” symbols. In another example, the chip pattern associated with each symbol is also defined in the standard. It will be appreciated that additional patterns may be defined, and other standards may allow for other patterns. The expected pattern 285 is passed through a preload process 283. The preload process shapes the pattern 285 into the form of an expected waveform. The possible expected waveforms 287 are then loaded into a reference table 281. In this way, the reference table 281 is loaded with a set of reference waveforms 287. Each of these waveforms may then be provided as a reference signal input 279. The reference signal 279 is passed through a preprocessing process similar to that performed on the baseband. The reference waveform 279 is correlated in correlator 299 with a version of the reference signal 296 that has been delayed using delay 292. Correlator 299 generates a processed reference signal 304. The processed reference signal 304 is then passed into correlator 306.

Correlator 306 then provides a result 308 that indicates the level of correlation between the processed baseband signal 302 and each processed reference signal 304. By correlating each of the reference signals in reference table 281, the reference signal having the best correlation may be found. Once the best correlating reference signal is found, an important characteristic of the baseband signal has been located. For example, the receiver process 275 may be used to locate a sync offset for an asynchronous baseband signal, or may be used to efficiently decode a baseband signal once synchronization has been found.

FIG. 9b shows another receiver process 310. The baseband portion 311 of receiver process 310 is similar to the process described with receiver process 275, so will not be described here in detail. However, receiver process 310 has a reference table 312 that is preloaded with reference signals already in the form for finally correlation. More specifically, each of the reference signals in reference table 312 is like one of the processed reference signals 304 described with reference to FIG. 9a. By loading the reference table 312 with the processed reference waveforms, the receiver circuitry may be simplified. The processed baseband signal and each processed reference signal are correlated in correlator 313, which produces a result 315 like result 308 described with reference to FIG. 9a.

Referring now to FIG. 10, process 325 is illustrated, which is useful for generating a table of reference signals for assisting in finding a sync offset. As generally described above, the 802.15.4 standard defines a preamble consisting of 8 sequential “0” symbols. Accordingly, it is only necessary to look for the “0” symbol to locate the preamble of a data frame. Since the process will only be looking for the “0” symbol, the “0” symbol 355 may be used as the expected pattern. The “0” symbol is then converted into its chip format in block 351. A chip table 353 is provided in the 802.15.4 standard for converting the symbol zero into its associated I and Q chips (see FIG. 12). The chip waveform may then be passed through a waveform shaping circuit 346 to further shape the chip waveform into an expected baseband signal 327. The expected baseband signal 327 may be represented as an I waveform 328 and a Q waveform 329. The I waveform, for example, has 16 chip portions, each one microsecond 333 in duration. In a similar manner, the Q waveform has 16 chips, which are staggered from the position of the I waveform chips. The expected baseband signal 327 is then sampled by an A to D converter 341. It will be appreciated that the expected baseband signal 327 may be mathematically modeled or may be actually generated and sampled using a receiver device.

The A to D converter 341 is operated at 4 times the frequency of the chips, which correspond to a frequency of 4 MHz. It will be appreciated that other sampling frequencies may be used consistent with this disclosure. Since the symbol 331 is 16 microseconds in duration, a 4 MHz sampling of a symbol will require 64 samples, each 250 nanoseconds 335 apart. In one example of the process, the A to D converter is a 1-bit A to D, which enables a particularly efficient synchronization process.

Once the expected waveform 327 has been sampled, then the reference table 342 can be loaded. For example, waveform R0 357 would represent an expected waveform sampled from sample 0 through sample 63. The next reference signal, R1 358 represents an expected waveform starting at sample 1 and continuing through sample 63 and ending with sample 0. In a similar way, reference signal R2 359 represents an expected waveform sample starting at sample 2 and continuing through sample 63 and ending with sample 1. The pattern of loading the reference table continues through expected reference waveform R63 361 which would represent an expected waveform if sampling started at sample 63 and then continues to sample 62. When the reference table 342 is fully loaded, the reference table contains 64 reference signals, with each reference signal representing an expected waveform depending on the possible starting points for sampling a “0” symbol.

Referring now to FIG. 11 a receiver portion 380 is shown. The receiver portion 380 has a reference table 384 loaded as described in FIG. 10. Accordingly, each of the reference waveforms 386 correspond to a sample offset of the expected preamble. Each of the reference waveforms is used as an input into a preprocessing section. For example, R0 388 is delayed 399 and correlated 401 with the output passed to correlator 410. In a similar manner, R1 390 is delayed 395 and correlated 402 with the result passed to correlator 411. Also, R2 392 is delayed 396 and correlated 403 with the result passed to correlator 412. Each of the reference waveforms is used as an input until all the possible reference waveforms are provided as input. For example, R63 393, the final waveform, is delayed 397 and correlated 404, with the result passed to correlator 413. It will be understood that the process of processing the reference signals may be done sequentially, or may include a multiplexing process which enables a parallel operation.

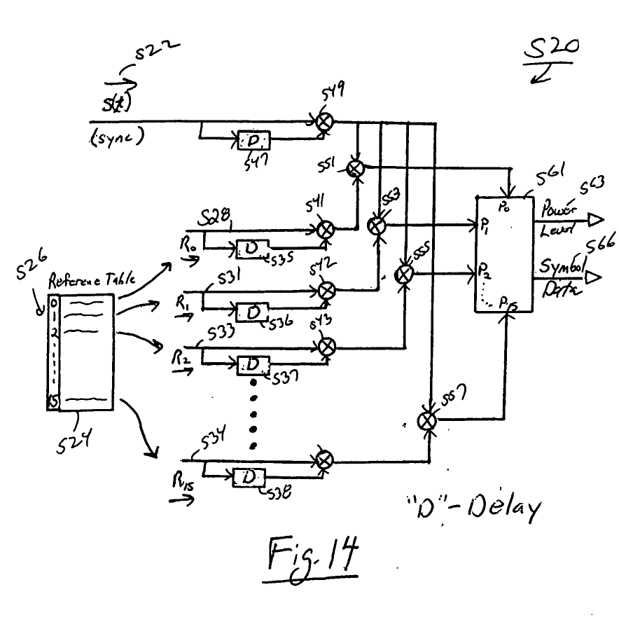

The baseband signal 382 is received in an asynchronous manner, and is delayed 406 and correlated in 407. The correlation in 407 removes the effects of any frequency offset and other degrading influences from the baseband signal, with the resulting signal then passed into correlators 410, 411, 412, and 413, where the processed baseband signal is correlated with each of the reference signals. It will be appreciated that the correlation process may be done sequentially, or may include a multiplexing process which enables a parallel operation. An accumulator or maximizing circuit 415 detects which of the correlators provides the highest power output, which would correspond to the best correlation. Since each reference signal is associated with a different sample start time, the reference signal having the best correlation will indicate the sample offset for the A to D converter. This sample offset may be used as a sync offset for synchronizing the receiver to the start position for each symbol in the baseband signal. The power level 417 of the best correlation and the index for sync offset 419 is reported from the receiver portion 380. For example, if R2 392 provided a power P2 into maximizer 415, and P2 was determined to be the highest power level, then the power level P2 would be recorded as power level 417, and the index “2” would be reported. In this way, the receiver now knows that a sync offset of 2 should be applied during the decoding process. With the sync offset known, a more efficient symbol decoding process is enable, such as the decode process illustrated in FIG. 13 and described more fully below. It will be appreciated that other decode processes may be used.

Referring now to FIG. 13, process 475 is illustrated. The process 475 is useful to load a reference table 440 for decoding symbols in a baseband signal. The process assumes that the detection process will be synchronized with the baseband signal. The sync signal may have been provided by the sync offset process described in association with FIG. 11, or by another network or receiver process. The table is loaded by referring to the symbol table 502 as provided in the 802.15.4 standard (see FIG. 12). The 802.15.4 standard uses 16 symbols 503 that are numbered “0” to “15”. The 802.15.4 standard also provides a chip table 499, which particularly identifies 32 chips corresponding to each of the symbols (See FIG. 12). Each of the symbols 503 in the symbol table 502 are then converted to chip waveforms in block 497. The chips may then be shaped in waveform shaping block 495 to correspond more closely to expected waveform shape for a chip waveform. The waveform-shaping block produces an expected baseband signal 477, which consists of an I waveform 478 and a Q waveform 479. As before, each chip is one microsecond 482 is duration, with one symbol 481 being 16 chips long. In this way, a single symbol 481 may be represented in chip form and sampled with the A to D converted 488. As before, the A to D converter is operated as 4 times the chip rate, which means the A to D, is operating at 4 megahertz. In one example, the A to D converter is a 1-bit converter, which enables a particularly efficient decoding process. It will be appreciated that the reference waveforms and conversion may be accomplished mathematically, or may be generated and sampled. It will also be appreciated that other frequency rates may be used consistent with this disclosure.

The reference table 490 is then loaded with expected waveforms 493 for each of the symbols 513. For example, R0 504 would include the A to D pattern corresponding to symbol “0”. In a similar manner, reference waveform R1 506 would include the sample pattern corresponding to symbol “1” and reference waveform R2 508 would correspond to the digitized pattern for symbol “2”. The table is continued to be loaded with each of the 16 symbols until R15 511 is loaded, which corresponds to the digitized waveform for symbol “15”. Once the table has been loaded, it is now ready to be used in a baseband decoding process.

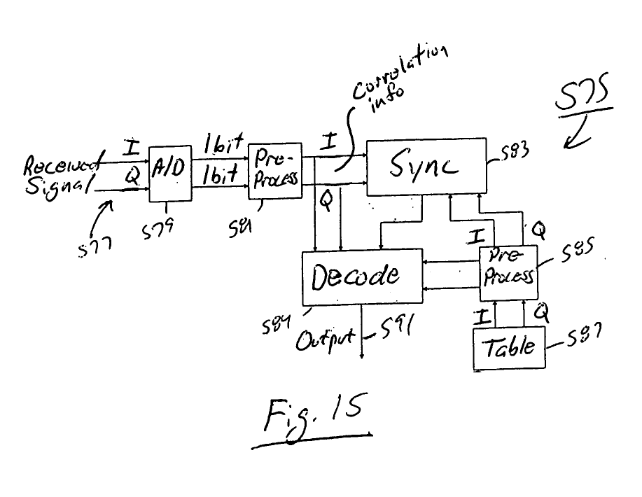

Referring now to FIG. 14 a receiver portion 520 is illustrated. The receiver portion 520 has a reference table 524 loaded as described in FIG. 13. Each of the reference signals 526 is preprocessed and then correlated with the baseband signal. For example, R0 528 is delayed 535 and correlated 541, with the result send to correlator 551. Reference waveform R1 531 is delayed 536 and correlated 542, with the result sent to correlator 553. Reference waveform R2 533 is delayed 537 and correlated 543, with the result sent to correlator 555. All reference signals are preprocessed in the same manner until R15 534 is delayed 534 and correlated 544, and its result sent to correlator 557. It will be understood that the process of processing the reference signals may be done sequentially, or may include a multiplexing process which enables a parallel operation.

The baseband signal 522 is also delayed 547 and correlated 549. Delaying and correlating the baseband signal removes the effects of a frequency offset and other degrading influences. The processed baseband signal is then correlated with the set of reference signals in correlator 551,553, 555, and 557. Each correlator reports its power level to a maximizer or accumulator 561 where the maximum power level 563 and symbol data 566 is reported. For example, if R2 533 provides the highest power correlation of any of the reference signals, then the maximizer 561 will report that power level 563 and also report that symbol data of “2” has been decoded. Once symbol data has been decoded, the process may be repeated to decode the next received symbol.

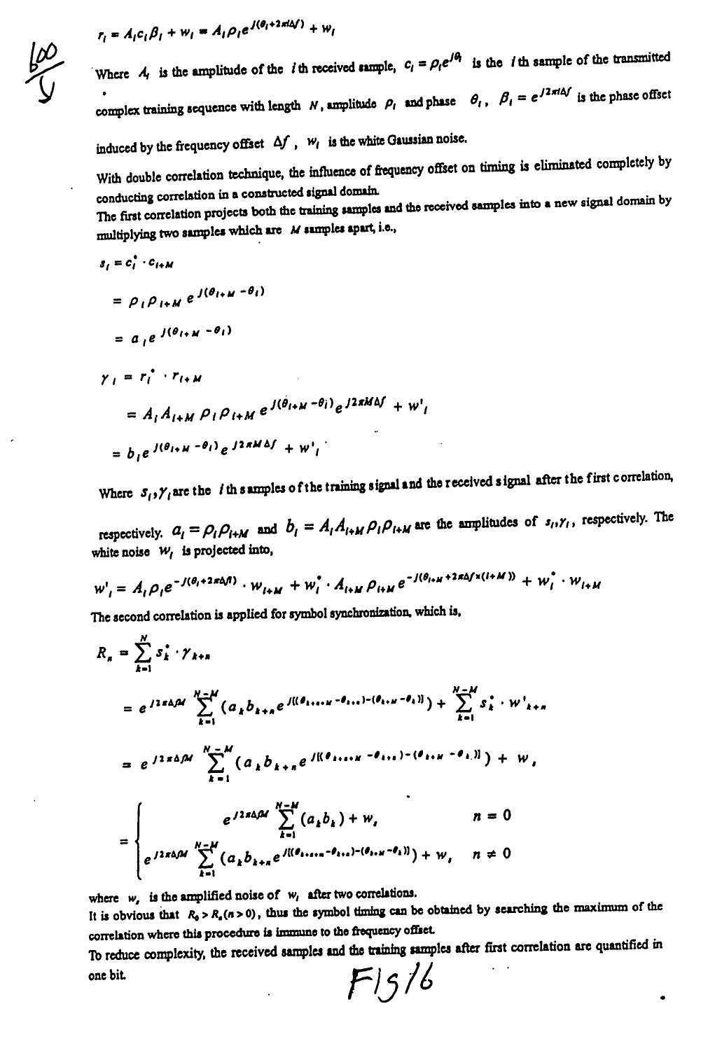

Referring now to FIG. 15 a receiver 575 is illustrated. The receiver 575 receives a baseband signal 577 into an A to D converter 579. The A to D converter is operating at 4 megahertz and passes its quantitized signals into a preprocessing section 581, the preprocessing section delays the baseband signal and correlates the baseband signal with its delayed version to provide an input into a synchronization process 583. A reference table 587 is provided which is first loaded with synchronization reference waveforms. These waveforms are preprocessed in block 585 and also presented to the synchronization process 583.

The synchronization process correlates the reference signals with the processed baseband signal, and identifies a sync index 589 for synchronizing the decode process 584 with the incoming baseband signal 577. Once the system has been synchronized, the reference table 587 is loaded with decoding reference waveforms. These decoding reference waveforms are then preprocessed 585 and passed to the decoding process 584. In the decoding process expected decoding waveforms are correlated with the processed baseband signal and the appropriate data symbol 591 identified. The decoding process is repeated to sequentially decoded symbols in the baseband signal.

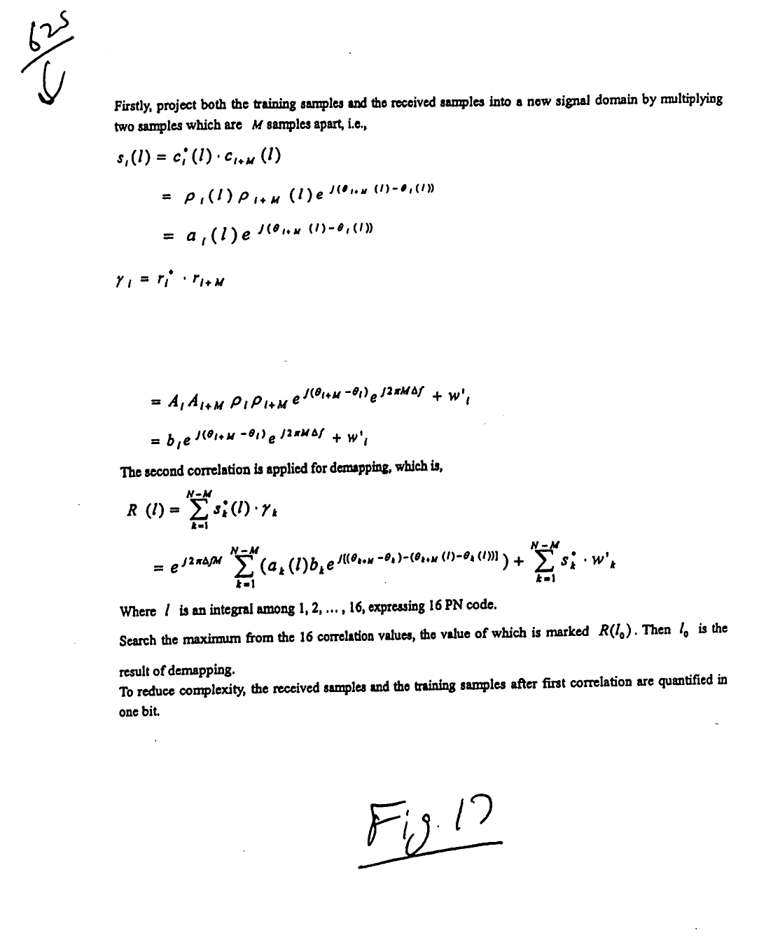

FIG. 16 provides mathematical support and description for the sync offset process. FIG. 17 provides mathematical support and description for the decode process.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

1. A baseband process, comprising:
predefining a set of reference signals;
receiving a baseband signal;
processing the baseband signal into a processed baseband signal;
correlating each of a plurality of the predefined reference signals with the processed baseband signal;
determining which of the plurality of reference signals has the best correlation with the processed baseband signal; and
identifying a characteristic of the baseband signal responsive to determining the best correlation.

2. The baseband process according to claim 1, wherein the set of reference signals comprises a set of sync waveform signals, each sync waveform signal indicative of a timing offset.

3. The baseband process according to claim 2, wherein the identifying step includes identifying a timing offset in the baseband signal.

4. The baseband process according to claim 3, wherein, responsive to identifying the timing offset, the set of reference signals is changed to comprise a set of decode waveform signals, each decode waveform signal indicative of a data symbol.

5. The baseband process according to claim 1, wherein the set of reference signals comprises a set of decode waveform signals, each decode waveform signal indicative of a data symbol.

6. The baseband process according to claim 1, where processing the baseband signal comprises generating a delayed baseband signal and correlating the baseband signal with the delayed baseband signal.

7. The baseband process according to claim 1, further including preprocessing each reference signal prior to correlating each reference signal with the preprocessed baseband signal, wherein the preprocessing of each reference signal comprises generating a delayed reference signal and correlating the reference signal with the delayed reference signal.

8. The baseband process according to claim 1, wherein the identifying step includes identifying a timing offset in the baseband signal.

9. The baseband process according to claim 1, wherein the identifying step includes identifying a data symbol in the baseband signal.

10. The baseband process according to claim 1, wherein processing the baseband signal includes converting the baseband signal into a digitized waveform using an analog to digital converter.

11. The baseband process according to claim 10, where the analog to digital converter is a one-bit A to D.

12. A process operating on a PHY layer of a receiver, comprising:
receiving a command from a MAC;
digitizing the baseband signal into a digitized baseband waveform;
determining a sync offset for the digitized baseband waveform;
adjusting the receiver according to the sync offset; and
decoding the digitized baseband waveform into symbol data.

13. The process according to claim 12, wherein determining a sync offset further comprises:
predetermining a set of sync reference signals, each sync reference signal indicative of a sync offset value;
processing the digitized baseband waveform;
correlating each of the sync reference signals with the processed baseband waveform;
identifying which of the correlated sync reference signals has the best correlation with processed baseband waveform; and
reporting the sync offset value associated with the best correlating reference signal.

14. The process according to claim 13, wherein processing the digitized baseband waveform includes correlating the digitized baseband waveform with a delayed version of the digitized baseband waveform.

15. The process according to claim 12, wherein decoding the digitized baseband waveform further comprises:
predetermining a set of symbol reference signals, each symbol reference signal indicative of a symbol;
processing the digitized baseband waveform;
correlating each of the symbol reference signals with the processed baseband waveform;
identifying which of the correlated symbol reference signals has the best correlation with processed baseband waveform; and
reporting the symbol associated with the best correlating reference signal.

16. The process according to claim 15, wherein processing the digitized baseband waveform includes correlating the digitized baseband waveform with a delayed version of the digitized baseband waveform.

17. A baseband process, comprising:
predefining a set of reference signals indicative of a sync offset;
receiving and processing a baseband signal;
correlating each of a plurality of the predefined reference signals with the processed baseband signal;
determining which of the plurality of reference signals has the best correlation with the processed baseband signal; and
determining the sync offset of the baseband signal responsive to determining the best correlation.

18. The process according to claim 17, wherein the predefining step further comprises:
providing a known sequence of symbols that are indicative of a preamble for a communication frame;
generating an expected waveform using the known sequence of symbols;
sampling the expected waveform at a sample rate to generate a sampled waveform, and storing a reference signal indicative of the sampled waveform;
shifting the sampled waveform to reflect a time offset, and storing another reference signal indicative of the shifted sampled waveform.

19. The process according to claim 18, wherein the expected waveform is represented by I and Q data.

20. The process according to claim 18, wherein the symbols are mapped to chips at a chip rate, and the sample rate is about four times greater than the chip rate.

21. A baseband process, comprising:
predefining a set of reference signals indicative of a set of data symbols;
receiving and processing a baseband signal;
correlating each of a plurality of the predefined reference signals with the processed baseband signal;
determining which of the plurality of reference signals has the best correlation with the processed baseband signal; and
determining that the baseband signal is indicative of one of the data symbols responsive to determining the best correlation.

22. The process according to claim 21, where in the predefining step further comprises:
providing a known set of symbols, the symbols being useful for generating a communication data frame;
generating an expected waveform for each one of the symbols; and
sampling each expected waveform at a sample rate to generate an associated sampled waveform, and storing a reference signal indicative of each associated sampled waveform.

23. The process according to claim 21, wherein the expected waveform is represented by I and Q data.

24. The process according to claim 21, wherein the symbols are mapped to chips at a chip rate, and the sample rate is about four times greater than the chip rate.

25. A process operating on an 802.15.4 compliant receiver, the receiver receiving a modulated signal having a carrier at about 2.4 GHz, the process comprising: predefining a set of reference signals;
receiving a baseband signal;
processing the baseband signal into a processed baseband signal;
correlating each of a plurality of the predefined reference signals with the processed baseband signal;
determining which of the plurality of reference signals has the best correlation with the processed baseband signal; and
identifying a characteristic of the baseband signal responsive to determining the best correlation.
